(19) United States
(12) Patent Application Publication
(10) Pub. No.: US 2013/0050393 A1
(43) Pub. Date: Feb. 28, 2013

(54) Multi-Channel External Video Compression Card

(71) Applicant: YEN-TSO CHEN, Taipei City (TW)

(72) Inventor: YEN-TSO CHEN, Taipei City (TW)

(21) Appl. No.: 13/572,698

(22) Filed: Aug. 13, 2012

(30) Foreign Application Priority Data
Aug. 26, 2011 (TW) 100215973

(51) Int. Cl. H04N 7/14

(52) U.S. Cl. 348/14.01; 348/E07.078

(57) ABSTRACT

The present invention provides an improved multi-channel external video compression card comprising a plurality of display connecting ports and a signal compression module; wherein each one of said display connecting ports comprises a signal conversion module for signal conversion and the signal compression module comprises a signal connecting port with a USB interface such that synchronized or simultaneous two-way video conference can be achieved and can be individually displayed on each user's screen in the video conference and such that an improved method of external connection to the computer for the users can be advantageously provided.

### (a) TECHNICAL FIELD OF THE INVENTION

The present invention is related to a multi-channel external video compression card, in particular, to an external video compression card provided for multiple two-way video conference synchronization and an improvement to the external multi-channel external video compression card capable of processing signal conversions.

### (b) DESCRIPTION OF THE PRIOR ART

As the technology improves from time to time, humans continue to contribute efforts in creating and improving greater innovations and technologies in light of overcoming inconvenience and limitations encountered in our daily lives such that a greater society of living standards can be achieved as the technologies lead us to better and more inconvenient lives and environment.

For video conferencing, it basically requires the essential equipment of video camera, display screen, mainframe, microphone, speaker, and most importantly, network connections and lines for remote video conference to be carried out successfully. However, known video conferencing equipment lacks the capability to be externally adapted to different types of video signal sources but to a compression module only. Since there is only one compression module available, it is only possible for one certain type of signal to be transmitted at one time; if various or multiple of signals are to be compressed, it would require greater hardware resources and costs associated therewith, which significantly reduces the competitiveness of the products and equipment in the market.

### SUMMARY OF THE INVENTION

A primary objective of the present invention is to allow various and multiple of display signals to be converted from analog to digital and vice versa via a plurality of discrete or individually independent signal conversion modules such that the signals compressed by the signal compression module can be sent out or transmitted in a relatively fast speed to achieve the improvements in the synchronization or simultaneous processing of multi-video conferences and the increase of the transmission speed thereof.

In order to achieve the abovementioned merits, the present invention provides a video compression card to be connected to a computer for data transmission therebetween, said video compression card comprises a plurality of display connecting ports and a signal compression module for compressing signals; each one of said plurality of display connecting ports comprising a signal conversion module for converting signals; said signal compression module comprising a signal connecting port to be connected to the computer for data transmission therebetween such that the computer is able to transmit signals to the external server for conferencing users to conduct online communications. Furthermore and according to the abovementioned structure, as multiple of users are involved and are to be communicated via online conferences, the video compression card of the present invention is connected to the computer connecting ports on the computer via signal connecting ports and the external electronic device or video cameras are electrically connected to the display connecting ports, during which the image screen read by the external electronic device is then transmitted to the signal conversion module for necessary conversions, and following which the signal is compressed with encryption by the signal compression module and then sent to the computer via the signal connecting ports thereof, and from which it is further transmitted to the external server. The internal data of the computer can be transmitted to the external server via a desktop instant software compression module and is further transmitted from the external server to each user in each video conference for its individual decompression of signal conversion. On the other hand, the present invention can also be configured to receive synchronized data transmitted from remote computers and to process decompression of the signal on the display screen. From the abovementioned technology it is able to solve the problem associated with known or traditional video conferencing equipment lacking the capability to be externally adapted to different types of video signal sources and to a compression module only, making it to process or transmit one certain type of signal at one time only and the problem of requiring greater hardware resources and costs associated therewith if various or multiple of signals are to be compressed, making it significantly less competitive in the market, and such that the abovementioned merits of the present invention are achieved and with improvements.

### BRIEF DESCRIPTION OF THE DRAWINGS

FIG. 1 is a perspective view of the preferred embodiment of the present invention;

FIG. 2 is a block diagram illustrating the preferred embodiment of the present invention;

FIG. 3 is a signal flow block diagram for application use of the preferred embodiment of the present invention; and

FIG. 4 is a functional block diagram for application use of display connecting ports of the present invention.

### DETAILED DESCRIPTION OF THE PREFERRED EMBODIMENTS

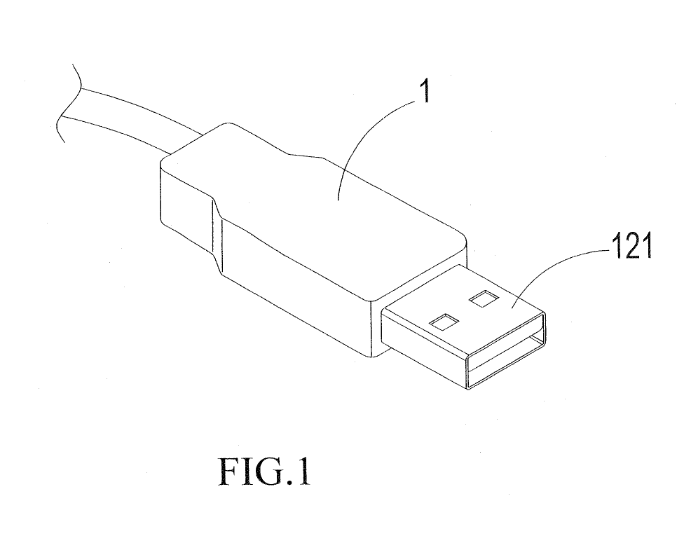

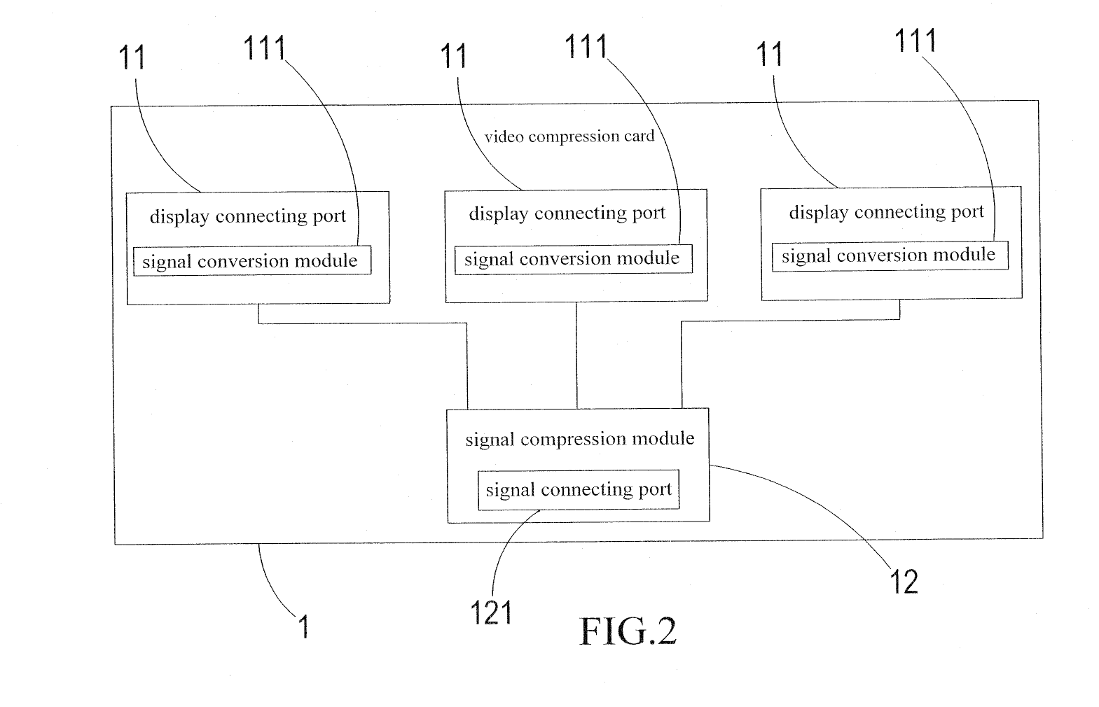

FIGS. 1 and 2 show a perspective view and a block diagram of a preferred embodiment of the present invention respectively. As shown in the figures, a video compression card 1 of the present invention is connected to a computer for data transmission and said video compression card 1 comprises:

A plurality of display connecting ports 11 and each one of said plurality of display connecting ports 11 comprises a signal conversion module 111 for converting signals. The display connecting ports can be Video Graphics Array (VGA) interface connecting ports, High-Definition Multimedia Interface (HDMI) connecting ports, National Television Systems Committee (NTSC) connecting ports, Phase Alternating Line (PAL) connecting ports or Component Video connecting ports. In addition, the signal conversion module can be a Video Graphics Array interface signal conversion module, High-Definition Multimedia Interface signal conversion module, National Television Systems Committee signal conversion module, Phase Alternating Line signal conversion module or Component Video signal conversion module; and

A signal compression module 12 (H.264) for compressing signals and electrically connected to said signal conversion module 111. The signal compression module 12 also comprises a signal connecting port 121 that is configured as a USB connecting port.

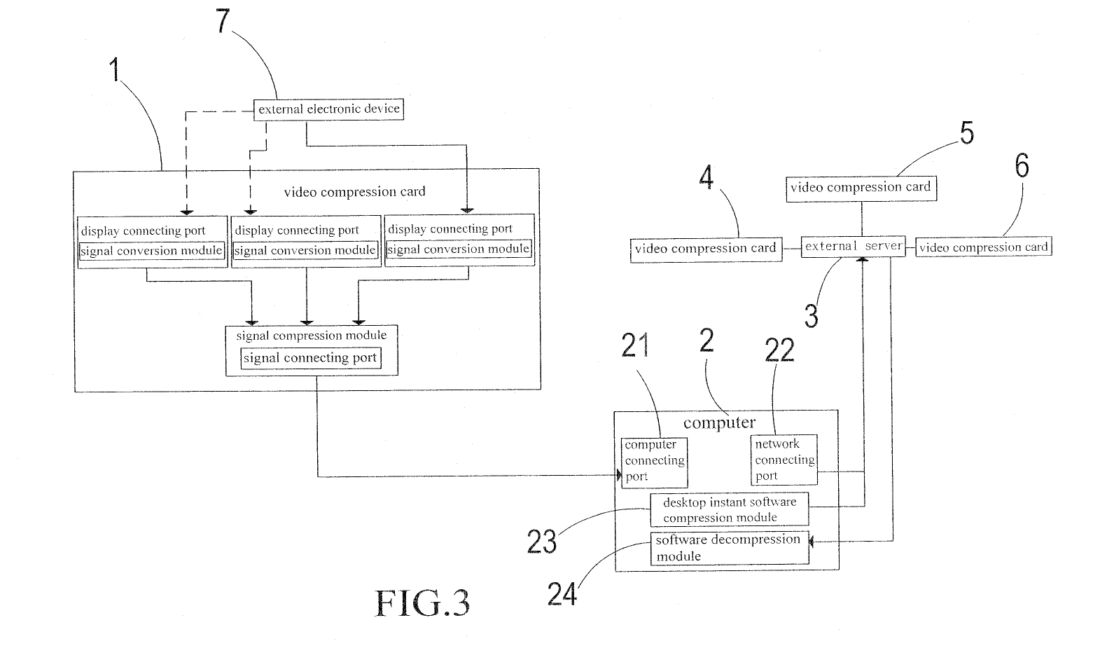

Based on the abovementioned structure and configured designs, the process of activation and signal flow of the present invention during its application of use is further described below along with the accompanied FIGS. 1 to 3 showing the perspective view, block diagram and signal flow block diagram of the preferred embodiment of the present invention respectively. As shown in the figures, the computer 2, as a tablet computer, laptop computer or desktop computer, comprises a computer connecting port 21 to be correspondingly connected to the signal connecting port 121 and a network connecting port 22 provided for an Ethernet network of a wireless transmission or a wired transmission and to be connected to an external server 3 for data transmission. The external server 3 can be connected with a multiple of computers 4, 5, and 6 for data transmission and each one of the computer 4, 5 and 6 is also equipped with a video compression card 1 of the present invention. In addition, computer 2 is advantageously provided with a desktop instant software compression module 23 and a software decompression module 24 such that the data to be displayed on the computer 2 can be instantly compressed via the desktop instant compression module 23 and to transmit it further to the external server 3. The software decompression module 24 is able to decompress the signal transmitted from the external server 3 and to display the data on the display device such as screen or projector. Furthermore, it is also possible to use the signal compression 12 to decompress the signal received from the external server 3 and to transmit it back to the computer 2 for its reading. Therefore, with such configuration, as multiple users are to conduct video conferences simultaneously or with synchronization, the video compression card 1 of the present invention is connected to the computer connecting ports 21 of the computer 2 via the signal connecting ports 121 thereof, and the external electronic device 7 or video camera is electrically connected to the display connecting port 11, during which the display screen read by the external electronic device 7 is instantly transmitted to the signal conversion module 111 for conversion, following which the signal is compressed with encryption by the signal compression module 12 and is transmitted to the computer 2 via the signal connecting port 121 thereof The signal is then transmitted from the computer 2 to the external sever 3 and is further transmitted from the external server 3 to each user of each video conference for its individual decompression of the conversion signals. On the other hand, the present invention can also be applied to receive data transmitted from the remote computer 2 simultaneously or with synchronization in order to decompress the data and to display it on the display device of the computer 2.

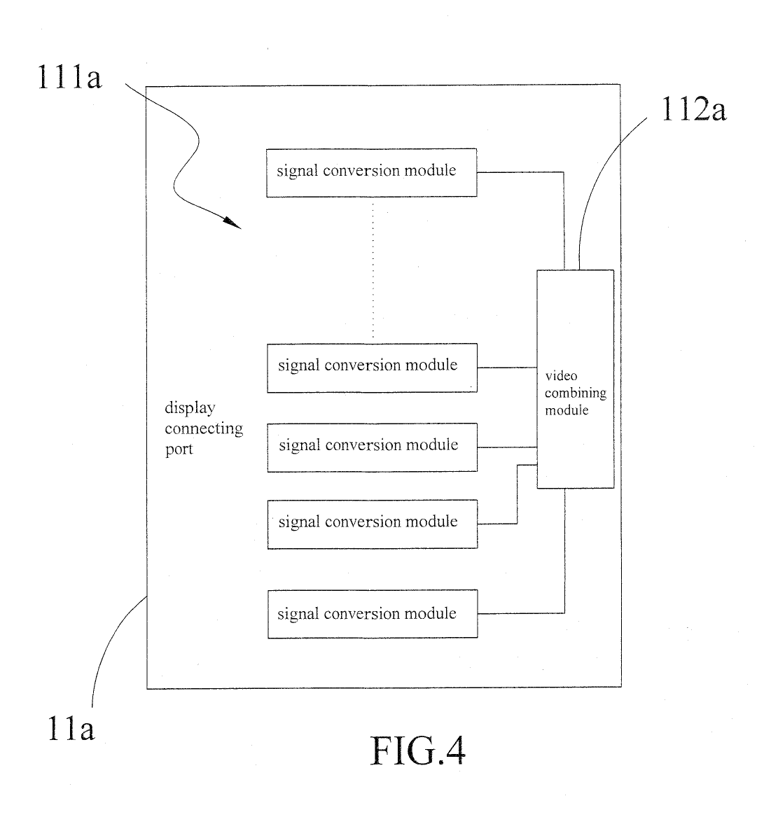

FIG. 4 shows a functional block diagram for application use of display connecting ports of the present invention. A shown in the figure, the display connecting ports 11a are of the type of National Television Systems Committee (NTSC) connecting ports and Phase Alternating Line (PAL) connecting ports. The displaying ports 11a further comprise a plurality of signal conversion module 111a, and each one of the signal conversion modules 111a is concurrently connected to a video combining module 112a for data transmission such that the video signals provided by each one of the signal conversion module 11a can be integrated by the video combining module 112a and further transmitted to the computer device for the display of the integrated video signals.

In view of the above with the accompanied figures, the use of the present invention demonstrates the following merits in comparison to known prior arts:

Allowing various and multiple of display signals to be converted from analog to digital and vice versa via a plurality of discrete or individually independent signal conversion modules 111 such that the signals compressed by the signal compression module 12 can be sent out or transmitted in a relatively fast speed to achieve the improvements in the synchronization or simultaneous processing of multi-video conferences and the increase of the transmission speed thereof.

What is claimed is:

1. An improved multi-channel external video compression card, said video compression card connected to a computer for data transmission, said video compression card comprising:
a plurality of display connecting ports; each one of said plurality of display connecting ports comprising a signal conversion module for converting signals; and
a signal compression module for compressing signals, electrically connected to said signal conversion module; wherein said signal compression module comprises a signal connecting port.

2. The improved multi-channel external video compression card according to claim 1, wherein said computer further comprises a desktop instant software compression module and a software decompression module.

3. The improved multi-channel external video compression card according to claim 1, wherein said display connecting ports further comprises said plurality of signal conversion module, and said plurality of signal conversion modules being concurrently connected to a video combining module for data transmission.

4. The improved multi-channel external video compression card according to claim 1, wherein said computer is one of the following of: a tablet computer, laptop computer and desktop computer.

5. The improved multi-channel external video compression card according to claim 1, wherein said display connecting ports are Video Graphics Array (VGA) interface connecting ports, High-Definition Multimedia Interface (HDMI) connecting ports, National Television Systems Committee (NTSC) connecting ports, Phase Alternating Line (PAL) connecting ports or Component Video connecting ports.

6. The improved multi-channel external video compression card according to claim 1, wherein said signal conversion module is a Video Graphics Array interface signal conversion module, High-Definition Multimedia Interface signal conversion module, National Television Systems Committee signal conversion module, Phase Alternating Line signal conversion module or Component Video signal conversion module.

7. The improved multi-channel external video compression card according to claim 1, wherein said signal compression module is a H.264 type of signal compression module.

8. The improved multi-channel external video compression card according to claim 1, wherein said signal connecting port is an USB connecting port.

9. The improved multi-channel external video compression card according to claim 1, wherein said computer comprises a computer connecting port to be correspondingly connected to said signal connecting port.

10. The improved multi-channel external video compression card according to claim 1, wherein said computer comprises a network connecting port.

11. The improved multi-channel external video compression card according to claim 10, wherein said network connecting port is provided for an Ethernet network of a wireless transmission or a wired transmission.

12. The improved multi-channel external video compression card according to claim 10, wherein said computer is remotely connected to an external server via said network connecting port.

13. The improved multi-channel external video compression card according to claim 12, wherein said external server is provided for connection with multiple of said computers for data transmission.
